(19) United States
(12) Patent Application Publication
(10) Pub. No.: US 2009/0234727 A1
(43) Pub. Date: Sep. 17, 2009

(54) SYSTEM AND METHOD FOR DETERMINING RELEVANCE RATINGS FOR KEYWORDS AND MATCHING USERS WITH CONTENT, ADVERTISING, AND OTHER USERS BASED ON KEYWORD RATINGS

(76) Inventor: William Petty, San Francisco, CA (US)

Correspondence Address: PERKINS COIE LLP, P.O. BOX 1208, SEATTLE, WA, 98111-1208, US

(21) Appl. No.: 12/047,229

(22) Filed: Mar. 12, 2008

(51) Int. Cl. G06Q 30/00; G06F 17/30; G06F 7/06

(52) U.S. Cl. 705/14; 707/5; 707/103 R; 705/1; 707/E17.017; 707/E17.045

(57) ABSTRACT

Systems and methods for determining relevance ratings for keywords associated with content are disclosed. A quantitative degree of relevance of keywords for a piece of content is determined by querying several reviewers. System users have a keyword record listing the keywords associated with content that a user has exhibited a threshold of interest in. Moreover, a cumulative value for the keywords is maintained by adding the degree of relevance of content keywords to the cumulative value of the keyword in the user's record. By finding correspondences between keywords in a user's record and keywords for pieces of content, advertisements, or other people using the system, a user's interest may be determined, and recommendations for content, advertisements, and potential friends or business contacts may be made to the user.

### TECHNICAL FIELD

The present invention relates to rating the relevance of keywords associated with content or advertising, and matching appropriate content or advertisements to system users.

### BACKGROUND

Keywords are words or phrases used to describe the contents of a document. Keywords may be used to categorize, search, and retrieve documents stored in an information system. For example, a user may enter one or more keywords in a search engine query to locate certain documents of interest to the user. A document associated with a keyword that matches the query keyword is returned to the user.

### SUMMARY OF THE DESCRIPTION

Systems and methods for determining relevance ratings for keywords associated with content are disclosed. Each piece of content stored in a database has several content keywords associated with it. Reviewers are requested to rate, quantitatively, the degree of relevance of one or more of the content keywords associated with a piece of content. Reviewers' ratings are averaged into a global relevance score for each content keyword for each piece of content.

Users of content of the system may also accumulate a user's keyword record based upon each piece of content accessed by the user in which the user has shown a threshold of interest. Content keywords for these pieces of content are added to the user's keyword record, and the global relevance score of each keyword is added to a cumulative value for that keyword in the user's record. A user's keyword record may reflect the interests of the user as the cumulative values of keywords in the user's record increase beyond a certain threshold.

Advertisements having associated keywords in an advertisement record may also be stored in the system. Advertisement keywords are generated from the keyword records of users who have shown an interest in the advertisement. The user keywords are added to the advertisement's keyword record, and a scaled form of cumulative values of keywords in the users' records are added to a cumulative value for that keyword in the advertisement's record. An advertisement's keyword record may be predictive of keyword records of users likely to be interested in that advertisement.

In one embodiment, user keywords and associated keyword values in a user's keyword record may be compared to content keywords and associated relevance scores for a piece of content to find correspondences that may indicate whether the user would be interested in the piece of content.

In another embodiment, user keywords and associated keyword values in a user's keyword record may be compared to advertisement keywords and associated advertisement keyword values for an advertisement to find correspondences that may indicate whether the user would be interested in the advertisement.

In another embodiment, user keywords and associated keyword values in a user's keyword record may be compared to the user keywords and associated keyword values in other users' records to find correspondences that may indicate whether two users would be interested in meeting.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Examples of a keyword relevance rating system and method are illustrated in the figures. The examples and figures are illustrative rather than limiting. The keyword relevance rating system and method are limited only by the claims.

FIG. 1 depicts a block diagram of a plurality of client devices, web application servers, and a keyword rating server coupled via a network, according to one embodiment.

FIG. 2 depicts a block diagram illustrating an example system for rating keywords, the system to include a keyword rating server coupled to a content database, and/or an advertisement database, and/or a user database, according to one embodiment.

FIG. 3A depicts a block diagram illustrating an example of a content database that stores content profile information, content, and content keyword information, according to one embodiment.

FIG. 3B depicts a block diagram illustrating an example of a user database that stores user profile information, user keyword information, and reviewer information, according to one embodiment.

FIG. 3C depicts a block diagram illustrating an example of an advertisement database that stores advertisement profile information, advertisement content, and advertisement keyword information, according to one embodiment.

FIG. 4 depicts a flow diagram illustrating an example process of determining relevance of keywords of a piece of content, according to one embodiment.

FIG. 5 depicts a flow diagram illustrating an example process of maintaining user keyword records, according to one embodiment.

FIG. 6A depicts a flow diagram illustrating an example process maintaining advertisement keyword records, according to one embodiment.

FIG. 6B depicts a flow diagram illustrating an example process of selecting advertisement to show to users, according to one embodiment.

FIG. 7 depicts a flow diagram illustrating an example process of selecting content recommendations for a user, according to one embodiment.

FIG. 8 depicts a flow diagram illustrating an example process of selecting people to introduce to a user, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

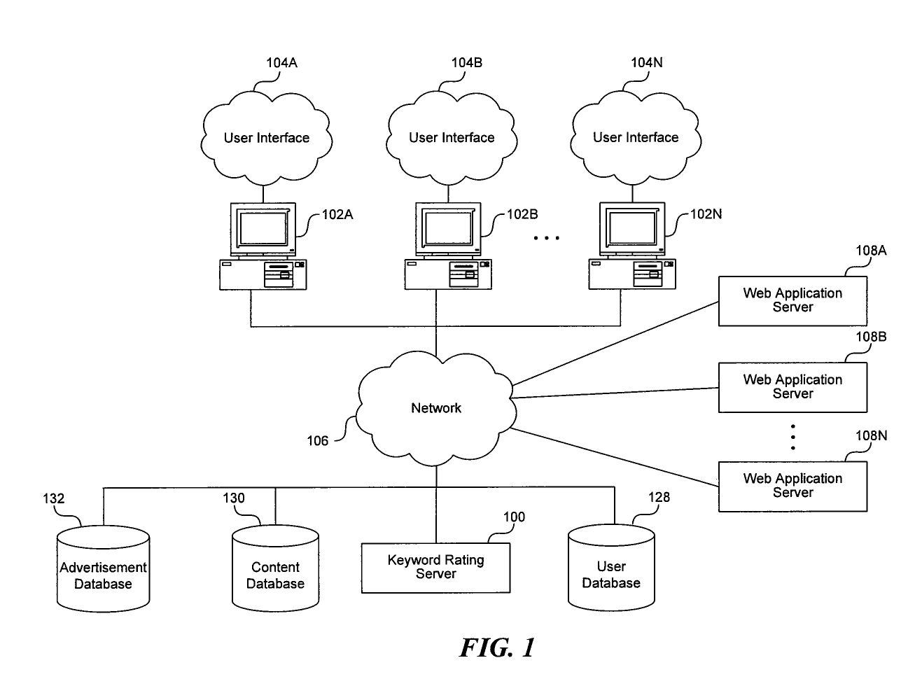

FIG. 1 illustrates a block diagram of a plurality of client devices 102A-N, web application servers 108A-N, and a keyword rating server 100 coupled via a network 106, according to one embodiment.

The plurality of client devices 102A-N can be any system and/or device, and/or any combination of devices/systems that is able to establish a connection with another device, a server and/or other systems. The client devices 102A-N typically include display or other output functionalities to present data exchanged between the devices to a user. For example, the client devices and content providers can be, but are not limited to, a server desktop, a desktop computer, a computer cluster, a mobile computing device such as a notebook, a laptop computer, a handheld computer, a mobile phone, a smart phone, a PDA, a BlackBerry™ device, a Treo™, and/or an iPhone, etc. In one embodiment, the client devices 102A-N are coupled to a network 106. In some embodiments, the client devices may be directly connected to one another.

The network 106, to which the client devices 102A-N are coupled, may be a telephonic network, an open network, such as the Internet, or a private network, such as an intranet and/or the extranet. For example, the Internet can provide file transfer, remote log in, email, news, RSS, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 may be any collection of distinct networks operating wholly or partially in conjunction to provide connectivity to the client devices, host server, and may appear as one or more networks to the serviced systems and devices. In one embodiment, communications to and from the client devices 102A-N may be achieved by, an open network, such as the Internet, or a private network, such as an intranet and/or the extranet. In one embodiment, communications may be achieved by a secure communications protocol, such as secure sockets layer (SSL), or transport layer security (TLS).

In addition, communications can be achieved via one or more wireless networks, such as, but is not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The client devices 102A-N can be coupled to the network (e.g., Internet) via a dial-up connection, a digital subscriber loop (DSL, ADSL), cable modem, and/or other types of connection. Thus, the client devices 102A-N can communicate with remote servers (e.g., web server, host server, mail server, instant messaging server) that provide access to user interfaces of the World Wide Web via a web browser, for example.

The user database 128, content database 130, and advertisement database 132 may store information such as software, descriptive data, images, system information, drivers, and/or any other data item utilized by parts of the host server 100 for operation. The user database 128, content database 130, and advertisement database 132 may be managed by a database management system (DBMS), for example but not limited to, Oracle, DB2, Microsoft Access, Microsoft SQL Server, PostgreSQL, MySQL, FileMaker, etc.

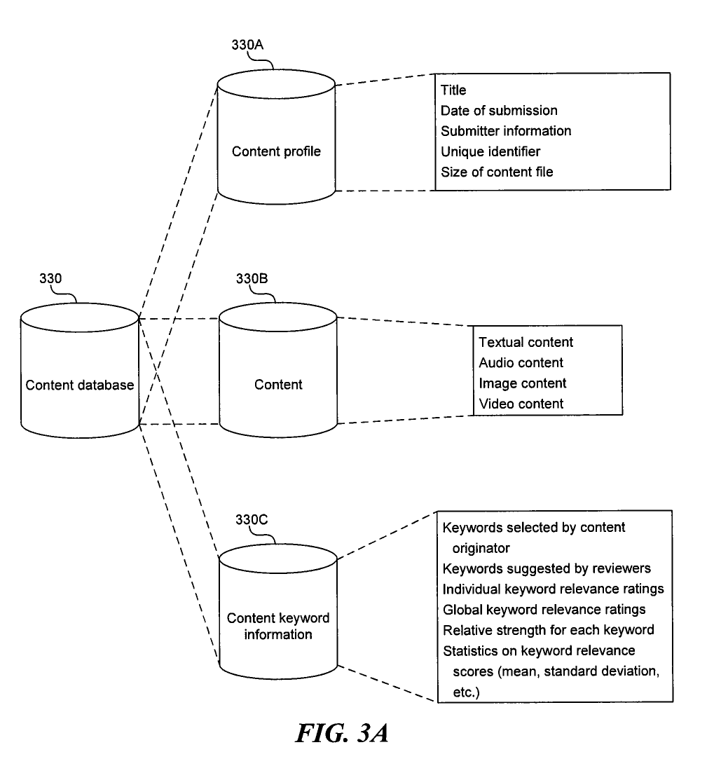

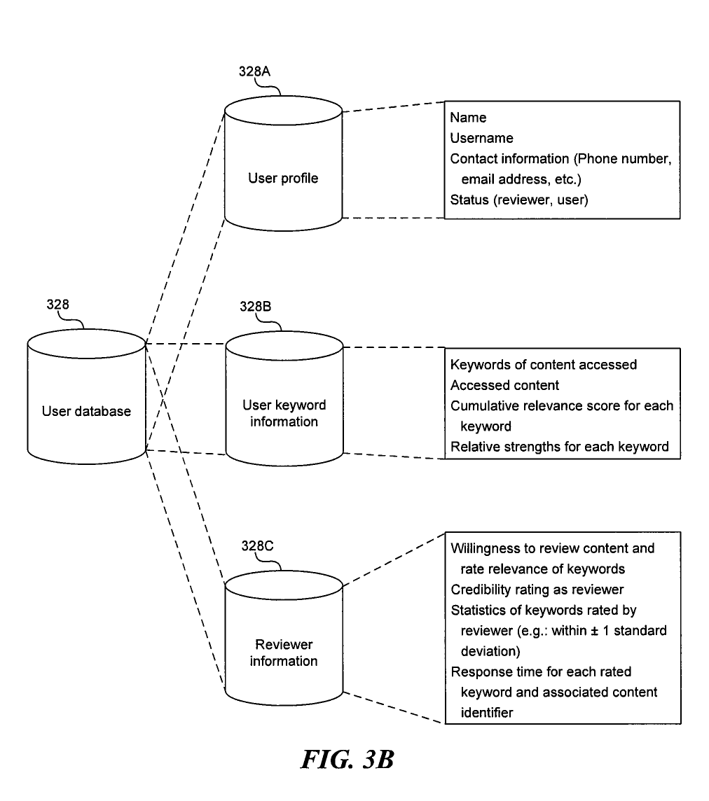

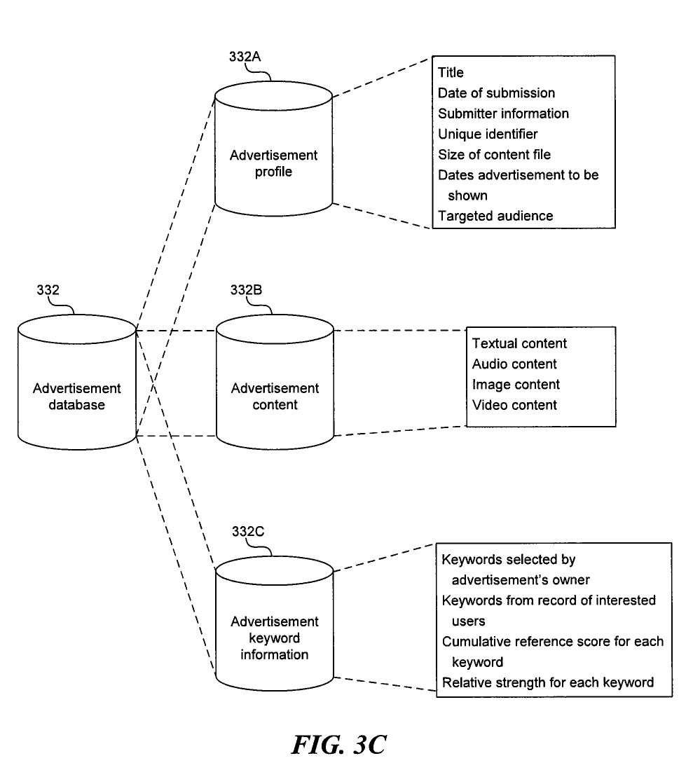

The databases 128, 130, 132 can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package. An example set of data to be stored in the user database 128, content database 130, and advertisement database 132 is further illustrated in FIG. 3A-3C.

The web application servers 108A-N can be any combination of software agents and/or hardware modules for providing software applications to end users, external systems and/or devices. The web application servers 108A-N can facilitate interaction and communication with the keyword rating server 100, or with other related applications and/or systems. For example, the web application servers 108A-N can receive content and/or commands from the keyword rating server 100.

The web application servers 108A-N can further include any combination of software agents and/or hardware modules for accepting Hypertext Transfer Protocol (HTTP) requests from end users, external systems, and/or external client devices and responding to the request by providing the requesters with web pages, such as HTML documents and objects that can include static and/or dynamic content (e.g., via one or more supported interfaces, such as the Common Gateway Interface (CGI), Simple CGI (SCGI), PHP, JavaServer Pages (JSP), Active Server Pages (ASP), ASP.NET, etc.).

In addition, a secure connection, SSL and/or TLS can be established by the web application servers 108A-N. In some embodiments, the web application servers 108A-N render the web pages with graphic user interfaces. The web pages provided by the web application servers 108A-N to client users/end devices enable user interface screens 104A-104N for example, to be displayed on client devices 102A-104N. In some embodiments, the web application servers 108A-N also perform authentication processes before responding to requests for resource access and data retrieval.

The keyword rating server 100 is, in some embodiments, able to communicate with client devices 102A-N and/or web application servers 108A-N via the network 106. In addition, the keyword rating server 100 is able to retrieve data from the user database 128, the content database 130, and the advertisement database 132. In some embodiments, the keyword rating server 100 is able to request a reviewer to provide keyword ratings for a piece of content, for example, over a network (e.g., the network 106) among various users of the client devices 102A-N.

Once pieces of content have been disbursed to reviewers and the keywords accordingly ranked, the keyword rating server 100 can, in one embodiment, provide the content having keywords ranked above a particular threshold to one or more of the web application servers 108A-N. The web application servers 108A-N can then provide end users (e.g., via client devices 102A-N) with access to the keyword-rated content (e.g., articles, notes, videos, images, etc.).

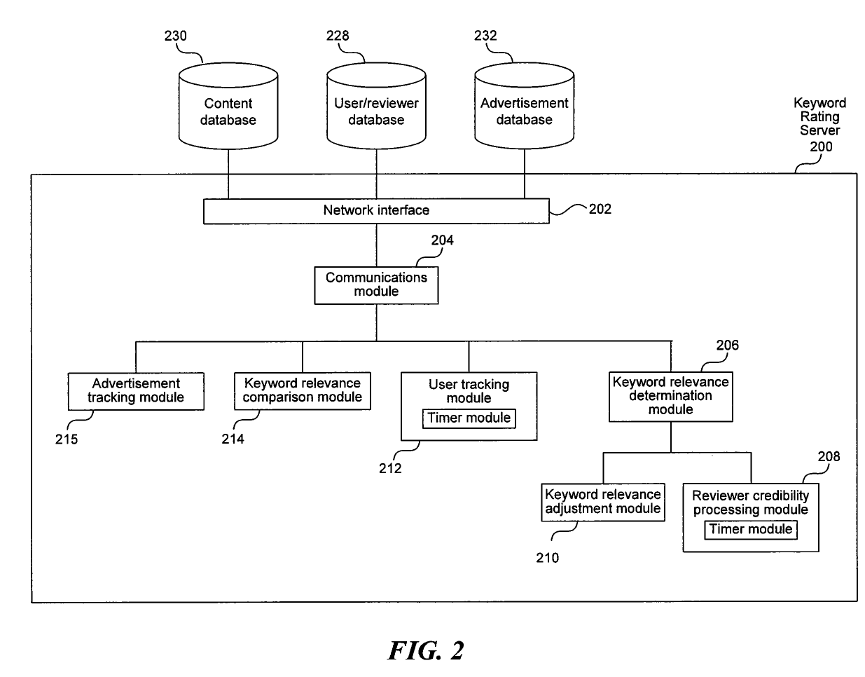

FIG. 2 depicts a block diagram illustrating a system for rating keywords for content, the system to include a keyword rating server 200 coupled to a user/reviewer database 228, a content database 230 and an advertisement database 232, according to one embodiment.

In the example of FIG. 2, the keyword rating server 200 includes a network interface 202, a firewall (not shown), a communications module 204, a keyword relevance determination module 206, a reviewer credibility processing module 208, a keyword relevance adjustment module 210, a user tracking module 212, a keyword relevance comparison module 214, and an advertisement tracking module 215. Additional or fewer modules may be included. The keyword rating server 200 may be communicatively coupled to the content database 230, the advertisement database 232, and/or the user database 228 as illustrated in FIG. 2. In some embodiments, the content database 230, the advertisement database 232, and/or the user database 228 are partially or wholly internal to the keyword rating server 200.

In the example of FIG. 2, the network interface 202 can be one or more networking devices that enable the keyword rating server 200 to mediate data in a network with an entity that is external to the host server, through any known and/or convenient communications protocol supported by the host and the external entity. The network interface 202 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

A firewall, can, in some embodiments, be included to govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure. In some embodiments, the functionalities of the network interface 202 and the firewall are partially or wholly combined and the functions of which can be implemented in any combination of software and/or hardware, in part or in whole.

In the example of FIG. 2, the keyword rating server 200 includes the communications module 204 or a combination of communications modules communicatively coupled to the network interface 202 to manage a one-way, two-way, and/or multi-way communication sessions over a plurality of communications protocols. In one embodiment, the communications module 204 receives data (e.g., audio data, textual data, audio files, etc.), information, commands, requests (e.g., text and/or audio-based), and/or text-based messages over a network. In one embodiment, the communications module receives communications from a network (e.g., Internet, wired and/or wireless network) initiated via a web-interface.

Since the communications module 204 is typically compatible with receiving and/or interpreting data originating from various communication protocols, the communications module 204 is able to establish parallel and/or serial communication sessions with users of remote client devices for data and command exchange (e.g., user information and/or user content).

In addition, the communications module 204 can manage log-on requests received from one or more users connecting to the keyword rating server 200 to submit content, submit content keyword ratings, communicate with other users, and/or otherwise access content. Connections are typically maintained until a user leaves the site. In some instances, authenticated sessions are managed by the communications module 204 for user logon processes.

For example, the platform may utilize a username/email and password identification method for authorizing access. The communications module 204 can gather data to determine if the user is authorized to access the system and if so, securely logs the user into the system. In other embodiments, other forms of identity authentication, include but is not limited to, security cards, digital certificates, biometric identifiers (e.g., fingerprints, retinal scans, facial scans, DNA, etc.) can be utilized and are contemplated and in accordance with this disclosure. A user may be able to specify and/or obtain a logon ID after subscribing or registering.

The communications module 204 may also establish communication sessions with third party content hosts (e.g., web application servers) to receive content requests and to provide results of the request. Third party content hosts can also register with the host system for accounts to receive content services based on rated keywords. Alternatively, third party content hosts can request content that satisfies a set of criteria from the host server. Services provided by the host server to third party content hosts may be fee-based. For example, the third party content hosts (e.g., customers) may be charged a fixed fee for ranking a certain amount of content. Additionally, the host server can license rated content submitted from users directly to the host server.

One embodiment of the keyword rating server 200 includes a keyword relevance determination module 206. The keyword relevance determination module 206 may be any combination of software agents and/or hardware components able to obtain reviewer ratings about the degree of relevance of keywords associated with a piece of content and to process the reviewer's ratings. The keyword relevance determination module 206 is, in most instances able to query reviewers' willingness to participate in reviewing content and rating the degree of relevance of keywords. Information regarding a user's willingness to participate in content reviewing can further be updated and/or stored in the user database 228.

The keyword relevance determination module 206, in one embodiment, is able to receive commands from the communications module 204. For example, the keyword relevance determination module 206 may receive pieces of content for keyword relevance rating. The communications module 204 may then retrieve reviewer information from the user database to identify either random users, users who are willing to review content and rate keywords, and/or reviewers with a high credibility rating. For example, the user database 228 may store information regarding a reviewer's credibility rating derived from a number of quantitative factors, such as consistency of previous keyword ratings with other reviewers' ratings or the time taken by a reviewer to review content and rate keywords. Reviewer credibility ratings may be used by the communications module 204 to select suitable reviewers. Alternatively, credibility ratings may not be considered in selecting reviewers. Furthermore, the keyword relevance determination module 206 may, in most instances, be able to communicate with the reviewer credibility processing module 208 to process credibility information related to reviewers and the keyword relevance adjustment module 210 to obtain information on how to adjust the global relevance scores of keywords.

Once reviewers have been selected and identified as willing to participate in the keyword rating process, the keyword relevance determination module 206 communicates with the communications module 204 to provide content to the reviewers for rating and/or otherwise scoring keywords. The communications module 204 can provide content to the reviewers via one or more of various communications protocols. For example, the communications module 204 can send the content to the reviewer via a wired and/or wireless network through email, messaging, http, text messages, etc. Once the reviewer has reviewed the content, the communications module 204 receives the rating for the degree of relevance of keywords from the reviewer. The reviewer response can also be received via any known and/or convenient communications protocol. Keyword relevance ratings are in some embodiments, sent to the content database 230 and/or the user/reviewer database 228 for storage and/or additional processing and analysis.

Once a predetermined number of reviewers have rated a keyword for a piece of content, the relevance ratings are averaged together by the keyword relevance determination module 206 to obtain a global relevance score for the keyword. The relevance ratings for a particular reviewer may be adjusted to have a lower weight depending upon the credibility rating of the reviewer, as determined by a reviewer credibility processing module 208. The global relevance score may be communicated through the communications module 204 to be stored in content database 230.

One embodiment of the keyword rating server 200 includes a reviewer credibility processing module 208. The reviewer credibility processing module 208 may be any combination of software agents and/or hardware components able to receive information about a reviewer's keyword rating performance and to perform further processing/analysis on the information.

In some instances, keyword ratings by a reviewer for a particular piece of content that fall outside of one or more variances of the mean ratings for the keyword may be flagged for further action, such as decreasing the credibility rating of the reviewer. For example, the meticulousness of the reviewer may be assumed to be lacking when the reviewer continuously assigns scores/ratings that are inconsistent with those provided by other reviewers. Reviewer ratings may be decreased if a reviewer is frequently assigning inconsistent keyword ratings compared to other reviewers.

In some embodiments, the time a reviewer takes to review the content and respond with keyword ratings may be taken into account. A reviewer's credibility rating may be decreased if the amount of time it takes the reviewer to review a piece of content is much less than the average time it takes other reviewers to review the same piece of content. Thus, the reviewer credibility processing module 208 may track the time elapsed from when a reviewer accesses the piece of content to be reviewed to when the reviewer responds with keyword ratings. The reviewer credibility processing module may include a timer module to perform the above functions.

The reviewer credibility processing module 208, through communications with the communications module 204 and the keyword relevance determination module 206, may access a reviewer's record in the user/reviewer database 228 to analyze the statistics related to a reviewer's keyword ratings and the data on the elapsed time associated with a reviewer's keyword ratings of a piece of content. Credibility ratings generated by the reviewer credibility processing module 208 may be communicated through the communications module 204 and the keyword relevance determination module 206 to be stored in the user/reviewer database 228.

One embodiment of the host server 200 includes a keyword relevance adjustment module 210. The keyword relevance adjustment module 210 may be any combination of software agents and/or hardware components able to process global relevance scores for keywords. Global relevance scores may be adjusted for human bias that skews keyword ratings because a reviewer may subjectively rank keywords in a manner inconsistent with actual meaningfulness of keywords. For example, empirical data may show that a reviewer may subconsciously rate a keyword too high when the relevance is fairly low, around 10% or less. Methods for adjustment of global relevance scores may include, but are not limited to, using a mapping function, a look-up table, or a fixed algorithm. Thus, a global relevance score of 80% may automatically be adjusted downward to 63% while a global relevance score of 70% may automatically be adjusted downward to 50%, for example. The mapping function, look-up table, or algorithm may be entered by a system administrator or system determined based upon collected data.

The keyword relevance adjustment module 210, through communications with the communications module 204 and the keyword relevance determination module 206, may store the adjusted global relevance scores for keywords for a piece of content in the content database 230.

One embodiment of the host server 200 includes a content use tracking module 212. The user tracking module 212 may be any combination of software agents and/or hardware components able to track a user's actions in accessing content to determine whether a user has shown significant interest in a piece of content.

A threshold of interest may be defined for each category of content, for example textual, video, or audio content. For example, the threshold of interest may be reached for a piece of textual content when the user scrolls through to the end of the article, and the threshold of interest may be reached for a piece of video or audio content when the user plays the content to the end. Thus, the user tracking module 212, through communications with the communications module 204, may determine when content is accessed by a reviewer and when a user has scrolled through a written article or played a video or audio content through to the end.

The user tracking module 212, in some embodiments, may also track the total time a user accesses a piece of content through a timer module. The timer module, in some embodiments, externally couples to a time server (e.g., World Time Server, NTP time server, U.S. Time server, etc.) to keep track of time. Generally, if a user takes much less than the average time it takes other users to scroll through a written article and review the relevance of keywords, it might be assumed that the user has not shown a threshold of interest in the article.

Once a user's actions in accessing a piece of content have reached a threshold of interest for a piece of content, the user tracking module 212 accesses the user's record in the user database 228 through the communications module 204. The user keywords in the record are noted and any content keyword not present in the user record that is associated with the accessed piece of content is added to the record. The user tracking module 212 computes a new cumulative value for each user keyword in the record based upon the previous cumulative value and the global relevance ratings associated with the respective content keywords.

One embodiment of the host server 200 includes a keyword relevance comparison module 214. The keyword relevance comparison module 214 may be any combination of software agents and/or hardware components able to quantitatively or qualitatively compare keyword relevance ratings. In some instances, the relative strengths of a list of content keywords with associated global relevance ratings for a piece of content may be calculated by scaling the global relevance ratings of all the keywords by the greatest global relevance rating in the keyword list. The keyword having the greatest global relevance rating may be referred to as the strongest keyword for a particular piece of content. After scaling, the strongest keyword in the list will have a relative strength of one, while the other keywords in have a relative strength between zero and one. It will be apparent to those of skill in the art that the relative strengths of all the content keywords associated with a particular piece of content may be proportionately scaled over any preferred range of relative strengths.

Likewise, the relative strengths of a list of user keywords with associated cumulative values may be calculated by scaling the cumulative values of all the user keywords by the greatest cumulative value in the user keyword list, and the relative strengths of a list of advertisement keywords with associated cumulative values may be calculated by scaling the cumulative values of all the advertisement keywords by the greatest cumulative value in the advertisement keyword list. The keyword having the greatest cumulative value in a user keyword list or an advertisement list may be referred to as the strongest keyword in the list. After scaling, the strongest keyword in a keyword list will have a relative strength of one, while the other keywords in the list will have a relative strength between zero and one. It will be apparent to those of skill in the art that the relative strengths of all the user keywords associated with a particular user or all the advertisement keywords associated with a particular advertisement may be proportionately scaled over any preferred range of relative strengths.

In some embodiments, the cumulative value corresponding to the strongest keyword in a user keyword list or an advertisement keyword list may be used to determine the likelihood that sufficient data has been collected about a user or an advertisement, respectively. Thus, if the cumulative value corresponding to the strongest keyword on a user keyword list is low, for example 50, statistically, it is less likely that the keyword list would accurately indicate the interests of the user than if the cumulative value were, for example, 1000.

The keyword relevance comparison module 214, in some embodiments, compares the strongest keyword in a user's record with that of a piece of content. If the strongest keyword in a user's record matches the strongest keyword in a piece of content, it is likely that the user may be interested in the piece of content. The piece of content matched to the user may be stored in the user database 228 through the communications module 204. Alternatively or additionally, the piece of content may be delivered to the user through the communications module 204.

In some embodiments, the keyword relevance comparison module 214 compares the strongest keyword in a user's record with that of an advertisement. If the strongest keyword in a user's record matches the strongest keyword in an advertisement, it is likely that the user may be interested in the product being offered in the advertisement. The advertisement matched to the user may be stored in the user database 228 and/or the advertisement database through the communications module 204. Alternatively or additionally, the advertisement may be delivered to the user through the communications module 204.

In some embodiments, the keyword relevance comparison module 214 compares the strongest keyword in a user's record with that of another user's record in the system. If the strongest keyword in a user's record matches the strongest keyword in another user's record, it is likely that the first user may be interested in associating with the second user. The second user matched to the first user may be stored in the user database 228 through the communications module 204. Alternatively or additionally, contact information for the second user may be delivered to the first user and/or contact information for the first user may be delivered to the second user through the communications module 204.

Other methods of comparing keyword relevance ratings include, but are not limited to, requiring a minimum number of keywords in two keyword lists to have a minimum relative strength or requiring a minimum number of keywords having a cumulative value greater than a predetermined value to match. Additional methods for comparing strengths of keywords are contemplated and are utilizable in determining reviewer rating/quality and are considered to be within the novel scope of this disclosure.

One embodiment of the host server 200 includes an advertisement tracking module 215. The advertisement tracking module 215 may be any combination of software agents and/or hardware components able to track whether a user shows an interest in an advertisement. Interest in an advertisement may be defined as when a user clicks on an advertisement or when a user actually buys a product advertised after clicking on the advertisement. Thus, the advertisement tracking module 215, through communications with the communications module 204, may determine when a user clicks on an advertisement and/or buys a product through the advertisement.

The keyword rating server 200 can be implemented using one or more processing units, such as server computers, UNIX workstations, personal computers, and/or other types of computes and processing devices. In the example of FIG. 2, the keyword rating server 200 includes multiple components coupled to one another and each component is illustrated as being individual and distinct. However, in some embodiments, some or all of the components, and/or the functions represented by each of the components can be combined in any convenient and/or known manner. For example, the components of the host server may be implemented on a single computer, multiple computers, and/or in a distributed fashion.

Thus, the components of the keyword rating server 200 are functional units that may be divided over multiple computers and/or processing units. Furthermore, the functions represented by the devices can be implemented individually or in any combination thereof, in hardware, software, or a combination of hardware and software. Different and additional hardware modules and/or software agents may be included in the keyword rating server 200 without deviating from the spirit of the disclosure.

FIG. 3A depicts a block diagram illustrating an example of a content database 330 that stores content profile information 330A, content 330B, and content keyword information 330C, according to one embodiment.

In the example of FIG. 3A, the profile information for content is stored in database 330A. Content profile information includes data related to the content including, but not limited to, title, date of submission, submitter information, a unique system identifier, and size of the content file.

The database 330 may also store content in database 330B. Content may include, but is not limited to, textual content, audio content, image content, and video content.

The database 328 may also store keyword information associated with a piece of content in database 330C. Keyword information includes, but is not limited to, keywords identified by the content's originator or a computer program if no list is submitted with the content, keywords suggested by keyword rating reviewers, all relevance ratings for each keyword provided by content reviewers, global keyword relevance ratings for each keyword, relative strengths of keywords, and statistics on keyword relevance scores, such as mean, standard deviation, etc.

FIG. 3B depicts a block diagram illustrating an example of a user database 328 that stores user data, according to one embodiment.

In the example of FIG. 3B, the profile information for content is stored in database 328A. User profile information includes data related to the user including, but not limited to, the user's name, a selected username within the system, contact information, such as phone number, email address, etc., and the status of the user, for example a content user or keyword rating reviewer.

The database 328 may also store a user's keyword record in database 328B. The keyword record may include, but is not limited to, keywords of content accessed by the user, a cumulative relevance score for each keyword, and system identifier of pieces of content accessed by the user.

The database 328 may also store reviewer information in database 328C. Reviewer information includes, but is not limited to, willingness to review content and rate relevance of keywords, a reviewer's credibility rating, the relevance ratings of all keywords rated by the user, statistics related to the keywords rated by the reviewer, such as standard deviation of other reviewer's ratings for the same keywords, and response time for the reviewer to review and rate keywords for a piece of content and the system identifier for the piece of content.

FIG. 3C depicts a block diagram illustrating an example of an advertisement database 332 that receives submitted advertisement content, according to one embodiment.

In the example of FIG. 3C, the profile information for advertisements is stored in database 332A. Advertisement profile information includes, but is not limited to, title, date of submission, submitter information, a unique system identifier, size of the content file, dates over which advertisement is to be shown to users, and targeted audience, if any,

The database 332 may also store advertisement content in database 332B. Advertisement content may include, but is not limited to, textual content, audio content, image content, and video content.

The database 332 may also store keyword information associated with an advertisement in database 332C. Keyword information includes, but is not limited to, keywords identified by the advertisement's owner, additional keywords found in users' keyword records who show interest in the advertisement, a cumulative value for each keyword, and relative strengths for each keyword.

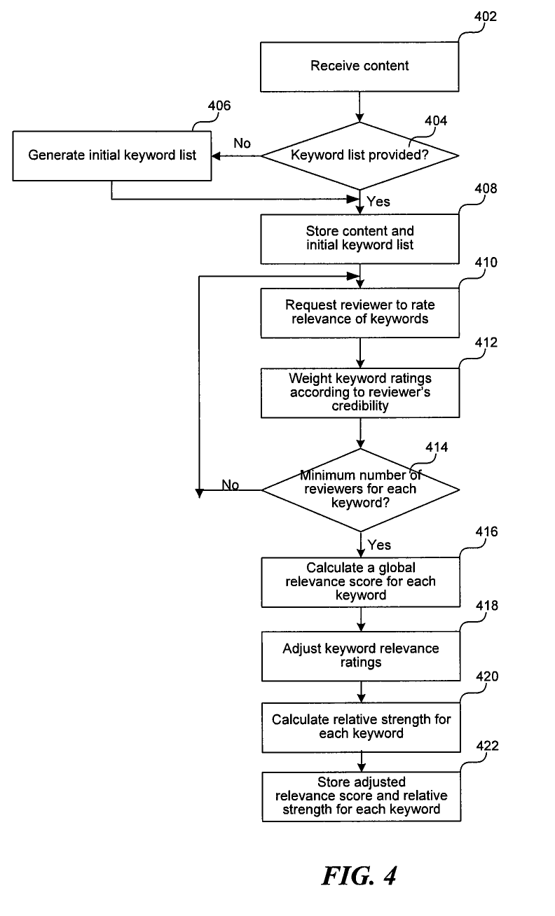

FIG. 4 depicts a flow diagram illustrating an example process of determining relevance of keywords of a piece of content, according to one embodiment.

At block 402, a piece of content is received. Content may be received from a number of sources, including but not limited to, the author of the content, the distributor of the content, or a third party content server. Content may be received directly via form submission, uploading, messaging, and/or emailing, etc. Categories of content may include, but is not limited to, textual content, audio content, image content, and video content.

At decision block 404, the system determines whether an initial keyword list has been included with the piece of content. If a keyword list has not been included (block 404—No), at block 406 an initial keyword list is generated. The content may be analyzed by a human editor or processed by a computer program to generate the initial keyword list, and the process proceeds to block 408. If the content included an initial list of associated keywords, (block 404—Yes), at block 408, the received content and the keyword list may be stored in a content database.

In some embodiments, content is organized and stored according to the subject matter and/or type of content, that is either explicitly specified, for example by the source of the piece of content, or system identified. The type of content and/or the subject matter relating to the content can assist the system in retrieving content for keyword analysis. For example, a user may request content related to a particular subject area.

At block 410, a reviewer is selected to review a piece of content and to rate the degree of relevance of the associated keyword list. The reviewer may be selected randomly or from among a list of volunteer reviewers or past reviewers. A keyword list associated with a piece of content may have over a dozen keywords. However, reviewers may be asked to rate the degree of relevance of only a subset of the keywords for the piece of content, for example three keywords, to prevent fatigue or impatience.

The content can be provided via one or more of many delivery channels. In addition to providing access to the actual content, a notification can be provided to the reviewer. Content and/or notifications can be displayed via a webpage, for example, upon logon. Additionally, content and/or notifications can be sent via email and/or via any other desktop delivery methods such as instant messages and/or pop-ups. Furthermore, content/notifications can be received via portable handheld devices via wired and/or wireless networks, for example, through text messages.

The reviewer is requested to rate the relevance of each chosen keyword on a sliding scale from zero to 100. Thus, the reviewer may be asked to answer the question, “If I were interested in <keyword>, the piece of content would have <X> degree of interest to me,” where the user is asked to fill in a value for X, ranging from 0% to 100%.

An example of keyword relevance ratings is illustrated for a piece of content that is an article about hiking in the Grand Canyon. The author of the article is an expert on the Grand Canyon, and thus places a particular emphasis on the location. A reviewer may decide that the article is 90% relevant to the keyword phrase “Grand Canyon”, 55% relevant to the keyword phrase “ultralight backpacking”, 20% relevant to the keyword phrase “blister treatment”, and only 6% relevant to the keyword “rattlesnakes”. All relevance ratings provided by reviewers are stored in the content database, the reviewer database, or both.

Reviewers may also suggest new keywords for a piece of content along with a relevance rating. Typically, a reviewer would suggest a keyword that he finds highly relevant to the content. If the keyword is not already part of the list of keywords, it may be added to the list. The new keyword would then also undergo similar review requests.

The content may be provided to the reviewer with an interface mechanism suitable for qualitative rating/scoring of keywords. For example, the reviewer can manipulate user interface components (e.g., scroll bars, slide bars, buttons, tabs, drop-down boxes, and/or a text box, etc.) to select and/or submit one or more keyword relevance ratings for the content. In some embodiments, reviewers can submit ratings without a specialized interface, for example, via email, messaging (instant), and/or otherwise text messaging.

At block 412, the reviewer's keyword ratings are weighted according to the reviewer's credibility. Credibility may be determined, in part, by a statistical analysis of the reviewer's keyword ratings compared to the keyword ratings given by other reviewers of the same keywords for the same piece of content. Thus, if the reviewer's keyword ratings are frequently inconsistent (as determined from statistical attributes, for example, outside one, two, or three standard deviations of the mean) with other reviewers' ratings, the reviewer credibility weighting function may be decreased.

Review time may also be used as an indicator of the level of meticulousness of the reviewer in reviewing the content. Generally, a reviewer's credibility weighting function may be decreased if the amount of time it takes the reviewer to review a piece of content is inconsistent with the time it takes other reviewers to review the same piece of content. The expected review time can be estimated for different types of content. For example, articles, other textual documents, and/or videos typically have a larger expected review time. Images and audio content may have lesser expected review times compared to textual content and video content. Of course, adjustments can be made according to the length of the text document, video content, audio content, etc. In addition, expected review times may be computed by statistically analyzing review-time data collected from tracking reviewers' actual expended review times. For example, the average review time and/or standard deviation can be computed for different types and length of content. Content length can be determined from file size or physical size (e.g., length of article in number of pages, image size, etc.) that the content occupies.

The time at which the reviewer accesses the content to be reviewed may be recorded. The time at which a keyword rating is submitted may also be recorded. In one embodiment, the amount of time for the reviewer to rate the keywords is estimated to be the difference in time between when a rating is submitted and when the reviewer first accesses the content. The review time can be tracked as an indicator of the quality of review.

Additional metrics are contemplated and are utilizable in determining reviewer credibility and are considered to be within the novel scope of this disclosure.

At decision block 414, the system determines whether a minimum number of reviewers have rated the relevance of each of the keywords for a piece of content. The minimum number may be predetermined or system determined. For example, each keyword may be required to have at least five individual reviewers rate the relevance of that keyword. If every keyword listed for a piece of content has not been reviewed by the minimum number of reviewers (block 414—No), then the system returns to block 410 to request another reviewer to rate more keywords. If each keyword has been reviewed by the minimum number of reviewers (block 414—Yes), the process continues to block 416.

At block 416, a global relevance score for each keyword is calculated. The relevance ratings provided by all reviewers are first weighted by the respective reviewer's credibility rating. Then all the weighted relevance ratings for each keyword are averaged to obtain the global relevance score.

At block 418, the global relevance score for each keyword may be adjusted. Global relevance scores may be adjusted for human bias that skews keyword ratings because a reviewer may subjectively rank keywords in a manner inconsistent with actual meaningfulness of keywords. For example, empirical data may show that keywords that are found to be very relevant may be assigned a relevance rating too high or too low. Alternatively, empirical data may show that keywords that are found to be not very relevant at all may be assigned a relevance rating too high or too low. Methods for adjustment of global relevance scores may include, but are not limited to, using a mapping function, a look-up table, or a fixed algorithm. The adjustment may be applied to particular ranges of relevance ratings or over the entire range of possible ratings. The adjustment may be user defined or system defined depending upon the data collected by the system. Furthermore, the adjustment may be applied at the time the complete set of reviewer keyword data is acquired, at a later time when more accurate adjustment functions are available, and/or at multiple points in time.

At block 420, the relative strength of each content keyword may be calculated by scaling the global relevance ratings of each of the keywords by the greatest global relevance rating in the keyword list. After scaling the content keywords for a piece of content, the strongest keyword in the list will have a relative strength of one, while the other keywords in have a relative strength between zero and one. The relative strength of each content keyword is stored in the content database.

At block 422, the adjusted global relevance score and the relative strength of each keyword is stored in the content database. The adjusted global relevance score may be re-adjusted as more accurate adjustment functions become available. Also, the relative strengths may be re-calculated as more keywords are identified and rated for the piece of content.

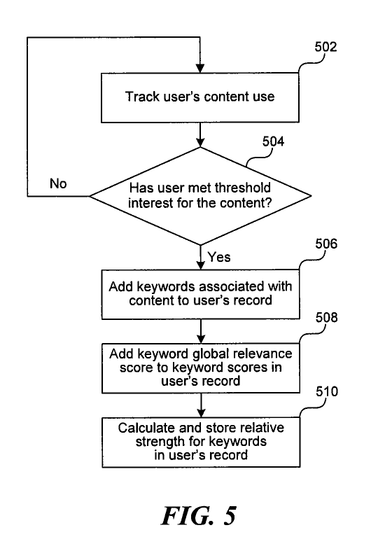

FIG. 5 depicts a flow diagram illustrating an example process of maintaining user keyword records, according to one embodiment.

At block 502, the system tracks a user's actions while the user is accessing content. In most instances, as content is being delivered to a user, the user's response may be monitored. For example, the amount of time the user views written content or plays video or audio content may be tracked by recording the time when the user begins to access the content or the time a user spends scrolling through a written article or runs video or audio content.

At decision block 504, the system determines if the user has met a threshold of use that indicates significant interest in the piece of content. The access time may be used as an indicator of user interest in the content. Because accessing content is assumed to take some amount of time, if the user spends a substantially shorter amount of time than the expected amount of time accessing content such as an article, the interest of the user in the piece of content may not be considered significant.

Thus, for the example of the written article, one indication of significant interest may occur when the user scrolls through to the end of the article. For the example of video or audio content, an indication of significant interest may occur when the time the user allows the content to play is substantially equal to the play time of the content. Yet another indication of interest may occur when a user accesses any piece of content more than once.

If a user has not met the threshold of interest for a piece of content (block 504—No), the process returns to block 502 to continue tracking the user's use of the content. If the user has met the threshold of interest (block 504—Yes), the process continues to block 506 where the keywords of the piece of content are added to the user's keyword record if the keywords are not already part of the record.

At block 508, the global relevance score for each keyword of the piece of content is added to the cumulative value for each keyword in the user's keyword record. For example, if a user reads three articles related to the Grand Canyon in one day, and the relevance ratings of the keyword phrase “Grand Canyon” for the three articles have a global relevance score of 95%, 60%, and 75%, respectively. At the end of the day, the user would have a cumulative number 230 (95+60+75) associated with the keyword phrase “Grand Canyon”. So the numerical value 230 is added to the cumulative value of the keyword phrase “Grand Canyon” in the user's keyword record, if the phrase is already present. If the phrase is new to the user's record, the cumulative value 230 is inserted into the record and associated with the keyword phrase “Grand Canyon”.

Statistically, when cumulative values for keywords are very low, the keywords may be more coincidental than significant in indicating the interest of the user. However, as the cumulative scores associated with a keyword increase, the keywords are statistically more accurate at reflecting the interests of users.

At block 510, the relative strength of each user keyword may be calculated by scaling the cumulative values of each of the keywords by the greatest cumulative value in the keyword list. After scaling the user keywords, the strongest keyword in the list will have a relative strength of one, while the other keywords in have a relative strength between zero and one. The relative strength of each user keyword is stored in the user database.

Relative strengths of keywords in a user's record may be compared to relative strengths of keywords in individual pieces of content to identify pieces of content that may be of interest to the user. Alternatively, relative strengths of keywords in a user's record may be compared to relative strengths of keywords in advertisements to identify advertisements that may be of interest to the user.

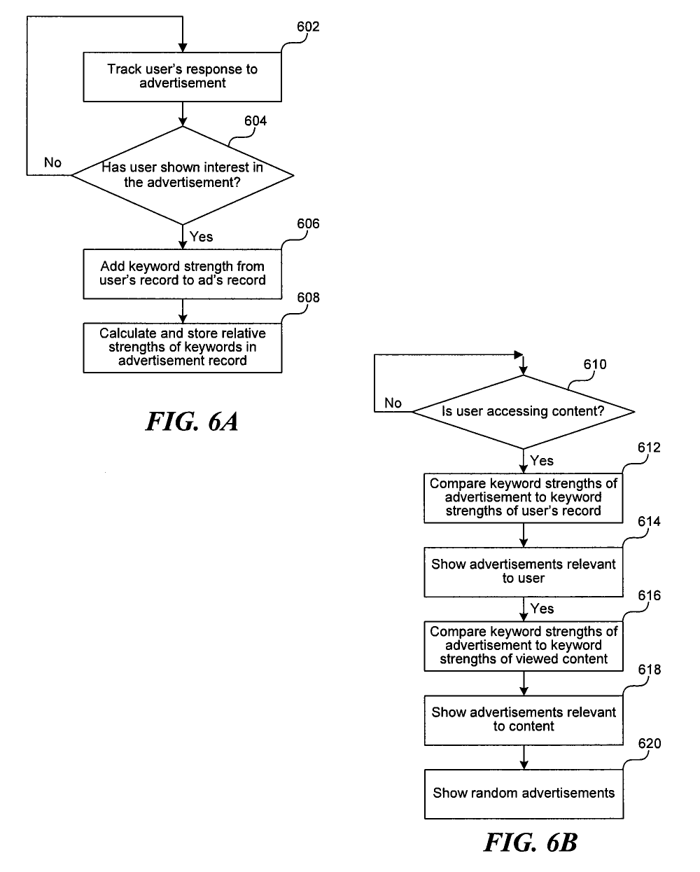

FIG. 6A depicts a flow diagram illustrating an example process of maintaining advertisement keyword records, according to one embodiment.

At block 602 the system tracks a user's response to being shown an advertisement alongside a piece of content. In most instances, as an advertisement is delivered to a user, if a user clicks on the advertisement or perhaps buys the product, this information may be tracked and stored.

At decision block 604, the system determines if the user has shown a significant degree of interest in the advertisement. Generally, a significant degree of interest may be indicated if the user either clicks on the advertisement or buys the product. If the user does not show any interest in the advertisement (block 604—No), the system continues to track the user's response to advertisement.

If the user shows some interest in the advertisement (block 604—Yes), at block 606, the keywords from the user's keyword record and their cumulative values are added to the advertisement keyword record associated with the advertisement if the user keyword is not already part of the advertisement's keyword record. If a keyword from the user's record is already in the advertisement's record, the cumulative value of the keyword in the user's record is added to the cumulative value of the keyword in the advertisement's record.

By aggregating cumulative values of keywords in an advertisement's keyword record, it may be possible to predict the relative keyword interest profile of users likely to be interested in a particular advertisement. Thus, when a user requests content, the user's keyword record may be compared to the keyword records of advertisements available to be delivered, and advertisements may then be selected according to keyword matches, keyword matches having a certain range of cumulative values, or any other type of correspondence between keyword cumulative values in a user's record and matching keyword cumulative values in an advertisement's record. The correspondence may be system determined after aggregating sufficient data about users' keyword records and interests.

At block 608, the relative strength of each advertisement keyword may be calculated by scaling the cumulative values of each of the keywords by the greatest cumulative value in the advertisement keyword list. After scaling the advertisement keywords for an advertisement, the strongest keyword in the list will have a relative strength of one, while the other keywords in have a relative strength between zero and one. The relative strength of each advertisement keyword is stored in the advertisement database.

FIG. 6B depicts a flow diagram illustrating an example process of selecting advertisement to show to users, according to one embodiment.

At decision block 610, the system determines whether a user is accessing content. If a user is not accessing content (block 610—No), the system remains at decision block 610 until a user accesses content stored in the content database.

If a user accesses content (block 610—Yes), at block 612 the system compares keywords in the user's keyword record and the keyword record of all advertisements available to be presented to a user. If there is a keyword match for one or more keywords, the cumulative values of that keyword in the user's record and the advertisement's record are compared. Alternatively, relative strength values for keywords in the user's record and the relative strengths values for the keywords in the advertisement record may be compared. In one embodiment, a correspondence may be defined as when a minimum number of keywords in a user's keyword record match the keywords in the advertisement's record.

In another embodiment, a correspondence between keywords may be defined by a minimum number of keywords in a user's keyword record having a cumulative value greater than a first value, and the same keywords in an advertisement's record having a cumulative value greater than a second value.

In another embodiment, a correspondence between keywords may be defined by a minimum number of keywords in a user's keyword record having a relative strength greater than a third value, and the same keywords in an advertisement's record having a relative strength greater than a fourth value.

Additional metrics based upon keyword relevance ratings are contemplated and are utilizable in determining whether an advertisement may be of interest to a user and are considered to be within the novel scope of this disclosure.

At block 614, advertisements determined to be of interest to the user are presented to the user. If a large number of advertisements are found to have a likelihood of interest to the user, the advertisements may be ranked in order of advertisements most likely to correspond to the user's interests. The likelihood rating may be a function of the number of corresponding keywords, the ranges of the cumulative values of keywords in a user's record and an advertisement's record, or the ranges of the relative strengths of keywords in a user's record and an advertisement's record.

At block 616, the system compares content keywords in the content keyword record of the piece of content the user is accessing or requesting access to and the keyword record of all advertisements available to be presented to a user. If there is a keyword match for one or more keywords, the relative strengths of that keyword in the content's keyword record and the advertisement's keyword record are compared. Similar to the comparison of a user's record to an advertisement's record, correspondence between the keywords of an advertisement and the piece of content may be used to determine which advertisements may be of interest to a user accessing the content.

At block 618, advertisements determined to be of relevant to the content accessed by the user are presented to the user. If a large number of advertisements are found to be relevant to the accessed content, the advertisements may be ranked in order of highest level of relevance to the accessed content. The likelihood rating may be a function of the number of corresponding keywords or the ranges of the relative strengths of keywords in a content keyword record and an advertisement keyword record.

At block 620, some random advertisements may be chosen to be presented to the user in addition to or instead of the advertisements shown to the user at blocks 614 and 618. Random advertisements may be useful if an advertiser wishes to target all audiences, regardless of user interest profile, in the hopes of establishing brand identity. Also, a user's interests may not be entirely captured by the user's keyword record. Thus, random advertisements may be of interest to a user despite a lack of correspondence of keywords.

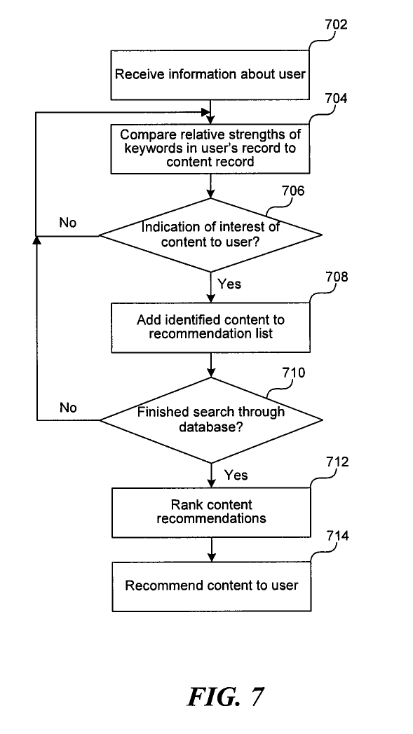

FIG. 7 depicts a flow diagram illustrating an example process of selecting content recommendations for a user, according to one embodiment.

A user in the user database may request a recommendation for content by providing a unique identifier, such as a name, a user name, system identification number, and/or password. Alternatively, a user may be selected from the user database, and recommendations on pieces of content that may be of interest to the user are identified. For both situations, the user keyword file in the user database is accessed by the system at block 702.

At block 704, the relative strengths of keywords in the user's record are compared to the relative strengths of keywords in a piece of content. All pieces of content having a strongest keyword that matches that of the user may be identified as potentially of interest to the user.

Additional metrics based upon keyword relevance ratings are contemplated and are utilizable in determining whether an advertisement may be of interest to a user and are considered to be within the novel scope of this disclosure.

At decision block 706, the user's keyword record is used as an indication of the subject matter that would be of interest to the user. The system determines if a piece of content in the content database would be of interest to the user using criteria such as comparing the strongest keyword for the user to the strongest keyword for a piece of content. Alternatively or additionally, an absolute global relevance value for the strongest keyword may be required to be greater than a predetermined value.

In one embodiment, more than one of the keywords in the user's keyword profile having the highest relative strength values may be required to be in the content keyword file of a piece of content and have a minimum global relevance value in order to consider that piece of content as potentially of interest to the user.

At block 708, a piece of content identified as being of interest to the user is added to a recommendation list for the user. The recommendation list may be stored in the user database.

At decision block 710, the system determines whether the entire data of content has been searched for piece of content of interest to the user. Alternatively, content in the content database may be categorized according to type of content, such as textual, image, video, or audio content, and only a specified category would be searched. In one embodiment, the user may request that only particular genres of content be searched, such as current events, historical events, fiction, or by topic. If keyword records of pieces of content matching the request criteria have not been evaluated (block 710—No), the process returns to block 704 to continue searching.

If the entire content database, or a specified particular subset of the content database, has been searched (block 710—Yes), the process continues to block 712 where all identified pieces of content are listed and may be ranked according to potential interest to the user. Criteria for ranking content include, but are not limited to, largest number of matching keywords, largest number of matching keywords having a cumulative value greater than a fixed value, total cumulative values of keywords having individual cumulative values greater than a fixed value.

At block 714, one or more of the highest ranked pieces of content from the list generated in block 712 may be recommended to the user. Additionally, the system may maintain a list of pieces of content already accessed by the user and eliminate that content from the recommendation list. Methods for transmitting recommendations to the user may include, but are not limited to, by postal service, email, newsletter, or as part of a marketing or advertising campaign.

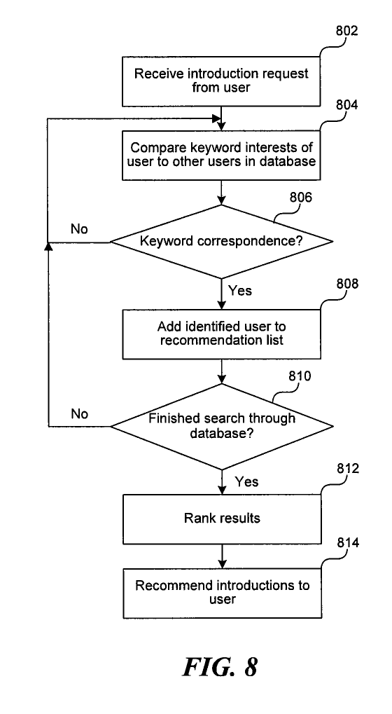

FIG. 8 depicts a flow diagram illustrating an example process of selecting people to introduce to a user, according to one embodiment.

A user in the user database may request a recommendation for a personal or business contact by providing a unique identifier, such as a name, a user name, system identification number, and/or password. Alternatively, a user may be selected from the user database, and recommendations on people that may be of interest to the user may be identified. For both situations, the keyword record of the user in the user database is accessed by the system at block 802.

At block 804, the cumulative values or the relative strengths of keywords in the user's record are compared to the cumulative values or relative strengths of keywords in the records of other users. All people having a strongest keyword that matches that of the user are identified as a person potentially of interest to the user.

Additional metrics based upon keyword relevance ratings are contemplated and are utilizable in determining whether a person may be of interest to a user and are considered to be within the novel scope of this disclosure.

At decision block 806, the user's keyword record is used as an indication of the subject matter that would be of interest to the user. The system determines if another person in the user database would be of interest to the user using criteria such as comparing the strongest keyword for the user to the strongest keyword for other users. Alternatively or additionally, a cumulative value for the strongest keyword may be required to be greater than a predetermined value.

In one embodiment, more than one of the keywords in the user's keyword profile having the highest relative strength values may be required to be in the user keyword file of a potential user recommendation and have a minimum cumulative value in order for that person to be considered as potentially of interest to the user.

At block 808, a person identified as having similar interests to the user is added to a recommendation list for the user. The recommendation list may be stored in the user database.

At decision block 810, the system determines whether the entire user database has been searched for users with matching interests. Alternatively, a user may request only certain groups of people be targeted, for example attorneys, doctors, women, or people within a certain age range. If keyword records of people in the user database matching the request criteria have not been evaluated (block 810—No), the process returns to block 804 to continue searching.

If the entire user database, or a subset of the user database, has been searched (block 810—Yes), the process continues to block 812 where all identified people are listed and may be ranked according to potential interest to the user. Criteria for ranking users include, but are not limited to, largest number of matching keywords, largest number of matching keywords having a cumulative value greater than a fixed value, total cumulative values of keywords having individual cumulative values greater than a fixed value.

At block 814, one or more of the highest ranked people from the list generated in block 812 may be recommended to the user. Additionally, the system may maintain a list of people already introduced to the user and eliminate that person from the recommendation list. Recommendations may be made as part of a dating service, business networking service, and/or social networking service.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. A method of creating a searchable database of content, comprising:
receiving pieces of content;
storing the pieces of content;
identifying content keywords for each piece of content;
determining a global relevance score for each content keyword for each piece of content, wherein determining a global relevance score includes receiving reviewer relevance score information for each content keyword and utilizing the reviewer relevance score information to determine the global relevance score;
storing the global relevance score for each content keyword for each piece of content,
wherein the content keywords and associated global relevance scores are used in a search for content in the database.

2. The method of claim 1, wherein the pieces of content are selected from a group consisting of text-based content, image-based content, video-based content, and audio-based content.

3. The method of claim 1, wherein determining a global relevance score comprises:
requesting a minimum number of reviewers to review a first piece of content to provide a reviewer relevance score for each content keyword associated with the first piece of content;
calculating the global relevance score for each content keyword based upon the reviewer relevance scores.

4. The method of claim 3, wherein each global relevance score is based upon a credibility score for each of the reviewers.

5. The method of claim 3, further comprising modifying the global relevance score for each content keyword to adjust for reviewer bias.

6. The method of claim 1, wherein determining a global relevance score comprises using a computer program to calculate the global relevance score for each content keyword for a piece of content.

7. A method of creating a user keyword record associated with a user, comprising:
determining whether the user has reached a threshold of interest for an accessed piece of content;
adding content keywords associated with the accessed piece of content as user keywords to the user's keyword record, if not already present in the user's keyword record;
processing a cumulative value and a new relative strength value for each content keyword in the user's keyword record based upon a global relevance score of each content keyword, a previous cumulative value, and a previous relative strength value associated with each content keyword in the user's keyword record,
wherein the user keywords and corresponding new relative strength values are compared with content keywords and corresponding relative strength scores of a piece of content to determine content of interest to the user.

8. The method of claim 7, wherein processing a new cumulative value comprises summing the previous cumulative value and the global relevance score.

9. The method of claim 8, wherein processing a new relative strength value comprises scaling the new cumulative value of each user keyword by a sum of all new cumulative values.

10. The method of claim 7, wherein the threshold of interest for a text-based piece of content is reached when the user scrolls to the end of the text-based piece of content.

11. The method of claim 7, wherein the threshold of interest for a video-based piece of content is reached when the user watches to the end of the video-based piece of content.

12. The method of claim 7, wherein the threshold of interest for an audio-based piece of content is reached when the user listens to the end of the audio-based piece of content.

13. A method of creating an advertisement keyword record associated with an advertisement, comprising:
determining when a user shows interest in the advertisement;
adding user keywords associated with the user to the advertisement's keyword record, if not already present in the advertisement's keyword record;
processing a new cumulative value and a new relative strength value for each of the user keywords in the advertisement's keyword record based upon a relative strength value of each user keyword and a previous cumulative value associated with the user keyword in the advertisement's record.

14. The method of claim 13, wherein interest is shown in the advertisement when the user clicks on the advertisement or buys an advertised product or service.

15. A method of recommending a piece of content to a user, comprising:
comparing content keywords and corresponding relative strength scores associated with the piece of content to user keywords and corresponding relative strength values associated with the user;
determining if a minimum degree of correspondence is established;
recommending the piece of content to the user if the minimum degree of correspondence is established.

16. The method of claim 15, wherein a minimum degree of correspondence is established if a strongest user keyword matches a strongest content keyword, or a predetermined number of user keywords matches the same predetermined number of content keywords, wherein the predetermined number of user keywords and predetermined number of content keywords have a minimum predetermined relative strength.

17. A method of selecting advertisements to be shown to a user, comprising:
comparing advertisement keywords and corresponding relative strength values associated with the advertisement to user keywords and corresponding relative strength values associated with the user;
determining if a minimum degree of correspondence is established;
presenting the advertisement to the user if the minimum degree of correspondence is established.

18. The method of claim 17, wherein a minimum degree of correspondence is established if a strongest user keyword matches a strongest advertisement keyword, or a predetermined number of user keywords matches the same predetermined number of advertisement keywords, wherein the predetermined number of user keywords and predetermined number of advertisement keywords have a minimum predetermined relative strength.

19. A method of introducing people based upon keyword interests, comprising:
comparing a first user's keywords and corresponding strength values to a second user's keywords and corresponding strength values;
determining if a minimum degree of correspondence is established;
introducing the first user and the second user if the minimum degree of correspondence is established.

20. The method of claim 19, wherein a minimum degree of correspondence is established if a strongest user keyword of the first user matches a strongest user keyword of the second user, a strongest user keyword of the first user matches a user keyword of the second user having a relative strength score greater than a first predetermined number, or a second predetermined number of user keywords of the first user matches the same second predetermined number of user keywords of the second user, wherein the second predetermined number of user keywords of the first user and the second predetermined number of user keywords of the second user have a minimum predetermined relative strength.

21. A system, comprising:
a content database for storing pieces of content, content keywords associated with each piece of content, and a global relevance score and relative strength for each content keyword;
a user database for storing user information, user keywords, and a user cumulative value and a user relative strength value for each user keyword;
a communications module for requesting reviewers to review a particular piece of content and rate a degree of relevance of one or more content keywords;
a keyword rating module for calculating the global relevance score and relative strength of each content keyword and calculating the user cumulative value and user relative strength value for each user keyword;
a keyword comparison module for determining a first degree of correspondence between content keywords of a particular piece of content and user keywords for a targeted user based upon global relevance scores or relative strength for the content keywords and user cumulative values or user relative strength values for the user keywords of the targeted user,
wherein the system recommends one or more pieces of content having a minimum first degree of correspondence to the targeted user.

22. The system of claim 21, further comprising an advertisement database for storing advertisements, advertisement keywords associated with each advertisement, a cumulative relevance score and a relative strength score for each advertisement keyword, and wherein the keyword comparison module further determines a second degree of correspondence between advertisement keywords of a particular advertisement and user keywords for a targeted user based upon cumulative relevance scores or relative strength scores for the advertisement keywords and user cumulative values or user relative strength values for the user keywords, and further wherein the system recommends one or more advertisements having a minimum second degree of correspondence to be shown to the targeted user.

23. The system of claim 21, wherein the keyword comparison module further determines a third degree of correspondence between user keywords for a first user and user keywords for a second user based upon user cumulative values or user relative strength values for the first user's keywords and user cumulative values or user relative strength values for the second user's keywords, and further wherein the system recommends one or users having a minimum third degree of correspondence to be introduced to the targeted user.
